(19) United States
(12) Patent Application Publication
(10) Pub. No.: US 2021/0108602 A1
(43) Pub. Date: Apr. 15, 2021

(54) SYSTEME D'INJECTION HYDRAULIQUE A CAME

(71) Applicant: Vianney RABHI, Lyon (FR)

(72) Inventor: Vianney RABHI, Lyon (FR)

(21) Appl. No.: 16/932,269

(22) Filed: Jul. 17, 2020

Related U.S. Application Data
(60) Provisional application No. 62/875,695, filed on Jul. 18, 2019.
(60) Provisional application No. 62/915,769, filed on Oct. 16, 2019.
(60) Provisional application No. 62/942,310, filed on Dec. 2, 2019.

(51) Int. Cl. F02M 59/12; F02M 61/18; F02M 61/04; F02M 61/20; F02M 59/46

(52) U.S. Cl. CPC F02M 59/12; F02M 61/1886; F02M 59/462; F02M 61/20; F02M 61/04

(57) ABSTRACT

The hydraulic injection system (100) with cam comprises an injection valve (50) housed in a tubular injection nozzle (54), a gap being formed between a valve stem (51) of said valve (50) and the inner surface of the tubular injection nozzle (54) to allow an injectable fluid (58) coming from pressurizing means (10) to flow, while a receiver piston (62) fixed with respect to said valve (50) receives on the one hand the pressure of the injectable fluid (58) to hold said valve (50) closed, and on the other hand, the pressure of a hydraulic fluid (60) to open said valve (50), an injection cam (67) being capable to move said receiver piston (62) via an emitter piston (69) and said hydraulic fluid (60).

The object of the present invention is a hydraulic injection system with cam designed, inter alia, to inject a pilot charge consisting of a mixture of air and easily inflammable fuel into a valve ignition pre-chamber or, more incidentally, into a pre-chamber formed by a spark plug with a shuttle electrode.

When said pilot charge is ignited by a spark, said pre-chamber ejects hot gas flares into the combustion chamber of an internal combustion engine in order to ignite a main charge contained in said chamber.

French patent application No. FR 17 50264 of 12 Jan. 2017 relating to a valve ignition pre-chamber, published on 13 Jul. 2018 under No. 3 061 743, is known. Also known is the French patent relating to a shuttle electrode spark plug, published on May 17, 2019 under No. 3 060 222. Both said applications belong to the applicant.

The said application and the said patent have commonly been the subject of two applications for French patents for improvements which also belong to the applicant. The first said application, dated 10 Sep. 2018, was registered under No. 18 58111 and concerns a magnetic return device for a valve. The second said application was registered on 13 May 2019 under No. 1904961 and concerns an ignition insert with active pre-chamber.

The inventions relating to the aforementioned patent applications and patents apply primarily to any reciprocating spark ignition engine of any type whatsoever whose main charge is heavily diluted with fresh air or with pre-cooled recirculated exhaust gases.

Subject to stable, rapid and sufficiently complete combustion, said main charge, highly diluted, increases the average and/or maximum thermodynamic efficiency of said engine receiving it compared to that of engines with spark ignition alone and thus reduces the fuel consumption of said engine for the same work produced.

It is in order to achieve this objective of stable, rapid and sufficiently complete combustion that said inventions are designed to produce a powerful, stable and safe ignition without which the expected reduction in fuel consumption cannot be obtained.

It can be seen that the inventions relating to the patent and patent applications cited above require an injector which injects a mixture of air and fuel directly into the pre-chamber, the fuel having been previously pressurized by a compressor.

It should be noted that the said injector must be as compact as possible in order to be integrated into the cylinder head of any reciprocating spark-ignition engine without interfering unduly with the intake ducts, the exhaust ducts or the cooling water chambers contained in the said cylinder head.

In addition to being compact, it can be seen from French patent application No. 1904961 that the said injector must advantageously have a nozzle of great length and small diameter. This particular configuration is necessary so that the said injector can be integrated into the cylinder head of any reciprocating internal combustion engine with spark ignition without interfering in a redhibitory manner with the functional organs and volumes of the said cylinder head. This implies in particular the provision of an injector provided with an injector needle of great length, the high mass of which requires a powerful actuator.

The injector in question must also offer high dynamics and permeability. These qualities are necessary in order to be capable to inject the pilot charge into the pre-chamber within the specified time, irrespective of the speed and load of the internal combustion engine, and despite the pressure of the air and fuel mixture at the inlet of the injector, provided to be relatively low.

This is because most reciprocating internal combustion engines with spark ignition are cooled by a water circuit whose temperature is maintained at around one hundred degrees Celsius. It follows from this that, preferably, the air and fuel mixture injector provided for in the inventions of French patent application No. FR 17 50264 and French patent No. 3 060 222 must also be maintained at a temperature not exceeding one hundred degrees Celsius, in order to avoid any additional device for heating the injector.

However, by way of a non-limiting example, if the temperature of the injector does not exceed one hundred degrees Celsius and if the richness of the air-fuel mixture it injects is 1.2 or 1.3, the pressure of the said mixture at the inlet of the said injector must not exceed fifty bars.

Indeed, above this limit pressure, part of the fuel contained in the mixture would condense on the internal walls of the injector and pass from the gaseous state to the liquid state. As a consequence of exceeding this saturating vapor limit pressure, the fraction of the pilot charge remaining in the gaseous state would be of lesser richness, would possibly be difficult to ignite, and its combustion would be potentially unstable. In addition, the highly reactive chemical species that result from the combustion of a rich mixture would no longer be produced in the desired quantities, and flare ignition of the main charge would become less efficient.

Taking into account what has just been said, in order to be capable to inject an air-fuel mixture of richness 1.2 to 1.3 maintained at one hundred degrees Celsius, the pressure at the inlet of the injector which has to inject the pilot charge into the pre-chamber described in the French patent application No FR 17 50264 and in the French patent No. 3 060 222 must not exceed fifty bars. This relatively low pressure has to be compensated by a high permeability of the injector.

In order to achieve this high permeability, it is not possible to increase the diameter of the injector too much, as this would make the injector too bulky. The most appropriate solution is to significantly increase the stroke of the injector needle, compared to that of a direct gasoline injector, which is of the order of fifty to sixty micrometers.

The problem is that increasing the needle stroke requires more than proportionally increasing the size and power of the solenoid actuator that moves the needle. Indeed, raising the needle further within the same time period increases the average speed of raising and lowering the needle. The impact of this increase in lifting and resting speed is greater on the sizing of the solenoid actuator that the reciprocating internal combustion engine is itself running at high speed.

In addition, an increased stroke of said needle moves the solenoid vane which actuates said needle away from the stator with which said vane cooperates. Since the force exerted by said vane on said needle decreases approximately due to the square of the distance between said vane and said stator, the constituent coil of the solenoid actuator must produce a very strong magnetic field. This is all the more true as the needle is moving away from its seat, a powerful return spring capable of bringing said needle back to its seat within the given time must be provided.

Increasing the stroke of the needle therefore leads to an actuator coil whose electric current requirement penalizes the efficiency of the internal combustion engine, and whose size and weight are hardly compatible with the gap available in the cylinder head of the engine. Moreover, the cost price of such an actuator coil will be potentially incompatible with the economic constraints of automotive mass production.

Moreover, the high resting speeds of said needle on its seat would produce an excessive power shock which would compromise the durability of said needle and said seat. The damage caused by this shock would be all the greater as the injector injects a low-density gaseous mixture whose lubricating properties are practically non-existent.

For solving these various problems the hydraulic injection system with cam according to the invention, in relation to the inventions disclosed in the French patent application No. FR 17 50264 and the French patent No. 3 060 222 and according to a particular mode of realization, makes it possible:
To produce a pilot charge injector with a nozzle of long length and small diameter, easily integrated into the cylinder head of a reciprocating internal combustion engine;
To provide a large injector needle lift which gives the pilot charge injector, despite its small diameter, a passage cross-section and a permeability several tens of times greater than that of a conventional direct gasoline injector, so that the said pilot charge injector ensures the filling of the pre-chamber over the entire operating range of the reciprocating internal combustion engine despite a limited pressure—for example at fifty bars—of the air and fuel mixture at the inlet of the said injector;
To produce a pilot charge injector with a long service life despite a high needle lift and despite the fact that the said injector injects a low-density gaseous mixture with practically non-existent lubricating properties;
To produce a pilot charge injector whose cost price is in particular compatible with mass production in the automotive industry;
Drastically reduce the weight and size of the actuator that moves the pilot charge injector needle, so that said actuator can be easily housed in or near the cylinder head of any reciprocating internal combustion engine.

The applications of the hydraulic injection system with cam according to the invention are not limited to the inventions relating to French patent application No. FR 17 50264 and French patent No. 3 060 222.

The hydraulic injection system with cam according to the invention can in particular inject gas or liquid into any active pre-chamber with or without a valve, or replace any direct or indirect injector according to the state of the art injecting a pure or compound gas and/or liquid, whether said injector is used in a heat engine of any type whatsoever, or in any other machine without limit of application.

The other characteristics of the present invention have been described in the description and in the dependent secondary claims directly or indirectly linked to the main claim.

The hydraulic injection system with cam comprises:
At least one injection valve which comprises a valve stem and terminates in an enlarged portion, or tulip, the latter forming a valve sealing surface, said valve being wholly or partially housed in a tubular injection nozzle terminated by an injection valve seat on which the valve sealing surface can rest sealingly, while a gap is formed between the valve stem and the inner surface of the tubular injection nozzle to allow an injectable fluid pressurized by pressurizing means to flow;
At least one nozzle inlet port provided in the tubular injection nozzle and through which the injectable fluid is introduced into said nozzle;
At least one receiver cylinder which is directly or indirectly fixed with respect to the end of the tubular injection nozzle;
At least one receiver piston fixed with respect to with the valve stem and housed in the receiver cylinder, the said piston being capable to move in longitudinal translation in the said cylinder and having an axial face on the injectable fluid side, which communicates with the internal volume of the tubular injection nozzle, and an axial face on the hydraulic fluid side, which forms, with the receiver cylinder, a variable-volume receiver chamber filled with a hydraulic fluid;
at least one hydraulic fluid supply device which is connected to the receiver chamber and making it possible to actuate the receiver piston can be actuated by means of the hydraulic fluid via an action hydraulic conduit.

The hydraulic injection system with cam according to the present invention comprises a receiver piston return spring which tends to move the receiver piston closer to a receiver cylinder head.

The hydraulic injection system with cam according to the present invention comprises permeable guide means which are directly or indirectly fixed with respect to the injection valve and/or the tubular injection nozzle, said means keeping the injection valve approximately centered in the tubular injection nozzle.

The hydraulic injection system with cam according to the present invention comprises a hydraulic fluid supply device which consists of an injection cam which has at least one cam profile held directly or indirectly in contact with an action axial face which is provided by an emitter piston housed in an emitter cylinder, said piston having—opposite the action axial face—an axial hydraulic fluid emitting face which forms an emitting chamber with the emitter cylinder, while the cam profile can move the emitter piston in longitudinal translation in the emitter cylinder when the injection cam is rotated by a driving source.

The hydraulic injection system with cam according to the present invention comprises an action hydraulic conduit which connects the emitter chamber to the receiver chamber, the conduit, emitter chamber and receiver chamber being filled with hydraulic fluid.

The hydraulic injection cam system according to the present invention comprises a cam profile which comprises at least one angular lifting sector which moves the emitter piston when said sector is in contact with the action axial face and when the injection cam is rotating, and at least one angular maintaining sector, circular and centered on the axis of rotation of said injection cam which immobilizes the emitter piston when said sector is in contact with the action axial face, and this, despite the fact that the injection cam is rotating.

The hydraulic injection system with cam according to the present invention comprises a cam profile which is held in contact with the action axial face by means of a rocker arm which is directly or indirectly supported on a cam housing in which the injection cam rotates.

The hydraulic injection system with cam according to the present invention comprises a rocker arm which is supported on the cam housing via a movable rocker point, the position of which between the cam profile and the action axial face can be varied by an injector lift actuator.

The hydraulic injection system with cam according to the present invention comprises a movable rocker point which consists of a moveable pressing roller which can roll or slide on a displacement track provided in the cam housing, said roller cooperating with a rocker track provided on the back of the rocker arm.

The hydraulic injection system with cam according to the present invention comprises a moveable pressing roller which receives at each of its ends an orientation pinion, said pinions being fixed in rotation, each of said pinions cooperating with an orientation rack secured on the cam housing.

The hydraulic injection system with cam according to the present invention comprises a moveable pressing roller which receives a worm wheel which cooperates with a worm whose axial position is fixed with respect to the cam housing, said worm being rotatably driven by the injector lift actuator.

The hydraulic injection system with cam according to the present invention comprises a moveable pressing roller which is provided with an internal thread in which the injector lift actuator can rotate a displacement screw which is fixed in position with respect to the cam housing but free to rotate about its longitudinal axis.

The hydraulic injection system with cam according to the present invention comprises an injection cam phase shifter which is interposed between the injection cam and the driving source.

The hydraulic injection system with cam according to the present invention comprises a tubular injection nozzle, the end of which terminates with the injection valve seat and is capped by a perforated diffuser.

The hydraulic injection system with cam according to the present invention comprises a perforated diffuser which inner wall is at least in part cylindrical and forms a small clearance between itself and the outer peripheral surface of the tulip so that said diffuser forms the permeable guide means.

The hydraulic injection system with cam according to the present invention comprises a charge pump which tends to introduce hydraulic fluid into the action hydraulic conduit via a feed check valve, said hydraulic fluid coming from a hydraulic fluid tank.

The hydraulic injection system with cam according to the present invention comprises at least one drainage orifice which is connected to a drainage conduit and which opens into the receiver cylinder, the axial face on the injectable fluid side and the axial face on the hydraulic fluid side always remaining axially positioned on either side of said orifice regardless of the position of the receiver piston.

The hydraulic injection system with cam according to the present invention comprises a receiver piston which has a drainage groove which communicates with the drainage orifice.

The hydraulic injection cam system according to the present invention comprises a receiver piston which is constituted by a first body which receives the axial face on the injectable fluid side and which is fixed with respect to the valve stem, and by a second body which may or may not be fixed with respect to said first body and which receives the axial face on the hydraulic fluid side, an external shoulder provided on one, the other or both of said bodies forming the drainage groove.

The hydraulic injection system with cam according to the present invention comprises a maximum range of displacement of the movable rocker point between the cam profile and the action axial face which is determined by at least one end-of-stroke stop.

The hydraulic injection system with cam according to the present invention comprises a displacement track which is fixedly connected to the cam housing by means of at least one track orientation ball joint.

The hydraulic injection system with cam according to the present invention comprises a receiver piston which is made up of at least one first body which receives the axial face on the injectable fluid side and which is fixed with respect to the valve stem, and of at least one second body which may or may not be fixed with respect to said first body and which receives the axial face on the hydraulic fluid side.

The hydraulic injection system with cam according to the present invention comprises a receiver piston which comprises an external shoulder arranged on one, the other or both bodies, said shoulder forming a drainage groove which communicates with at least one drainage orifice which is arranged in the receiver cylinder and which is connected to a drainage conduit.

The description that follows, together with the drawings annexed hereto and provided as non-limiting examples, will give a better understanding of the invention, its characteristics and the advantages it is likely to provide:

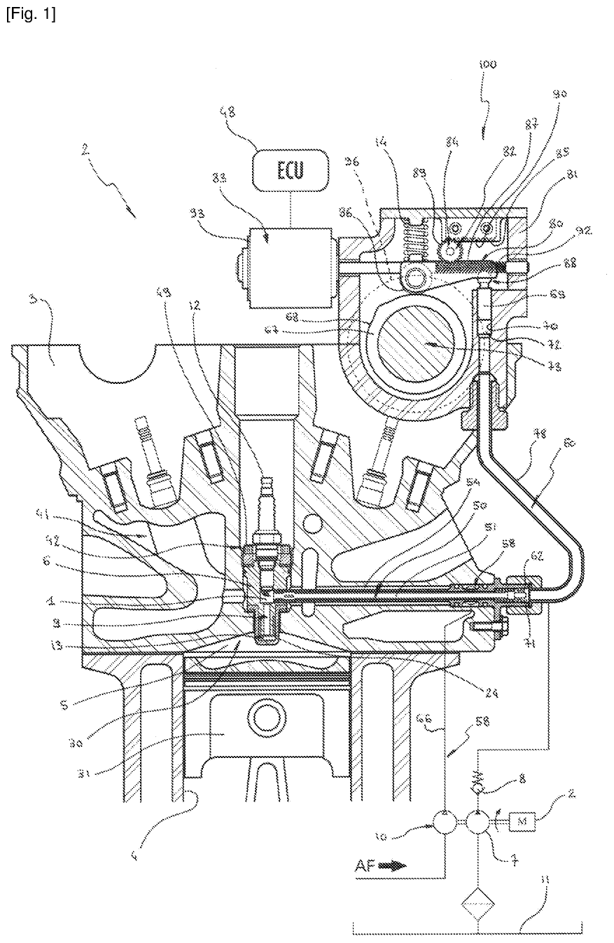

FIG. 1 is a schematic sectional view of the hydraulic injection system with cam according to the invention as it can be installed in the cylinder head of an internal combustion engine equipped with a valve ignition pre-chamber according to French patent application No. FR 17 50264 and an ignition insert with active pre-chamber according to French patent application No. 3 060 222.

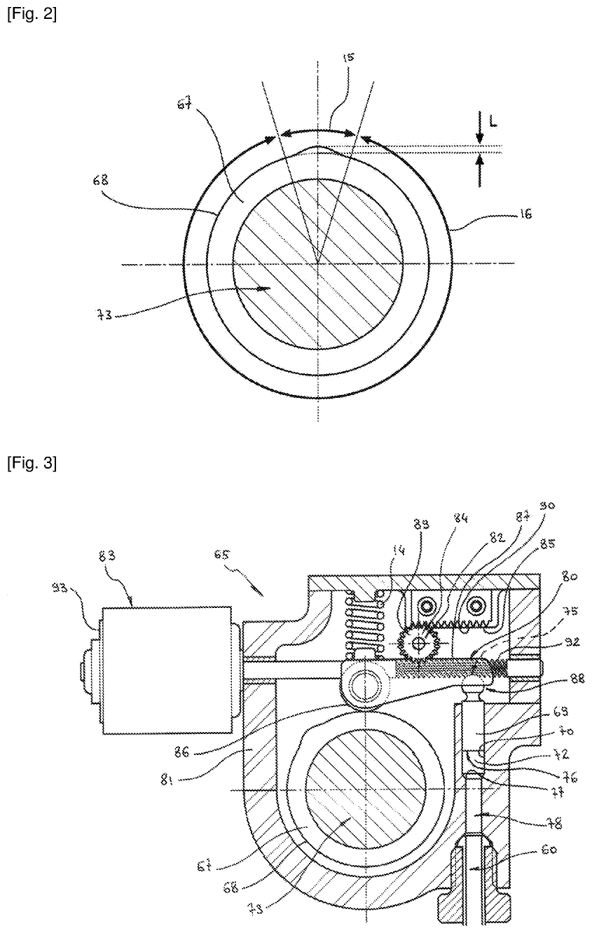

FIG. 2 is a schematic sectional view showing the angular lifting and maintaining sectors as can be accommodated by the cam profile of the hydraulic injection system with cam according to the invention.

FIGS. 3 to 5 are schematic sectional views illustrating the operation of the injection cam and the emitting piston of the hydraulic injection system with cam according to the invention, said cam cooperating with a rocker arm whose lever arm can be varied according to the position of a moveable pressing roller, said position being controlled by an electric stepper motor via a worm and a worm wheel.

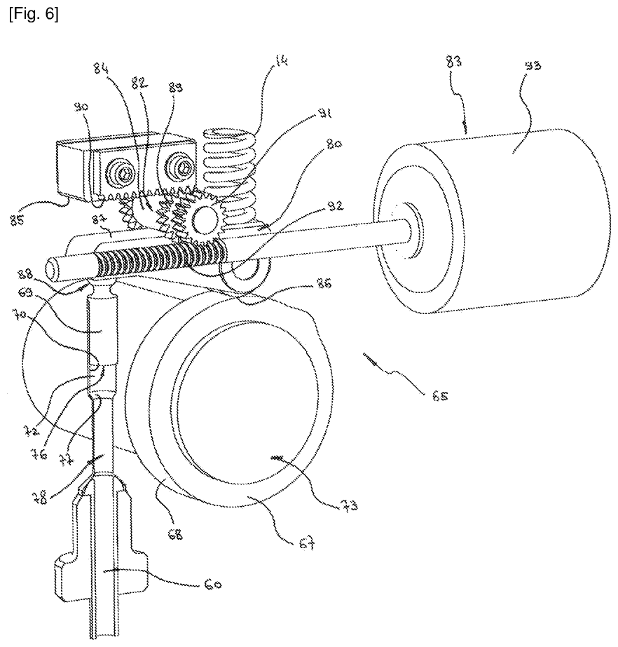

FIG. 6 is a three-dimensional view of the injection cam of the hydraulic injection system with cam according to the invention and the main functional components shown in FIGS. 3 to 5 with which the cam cooperates.

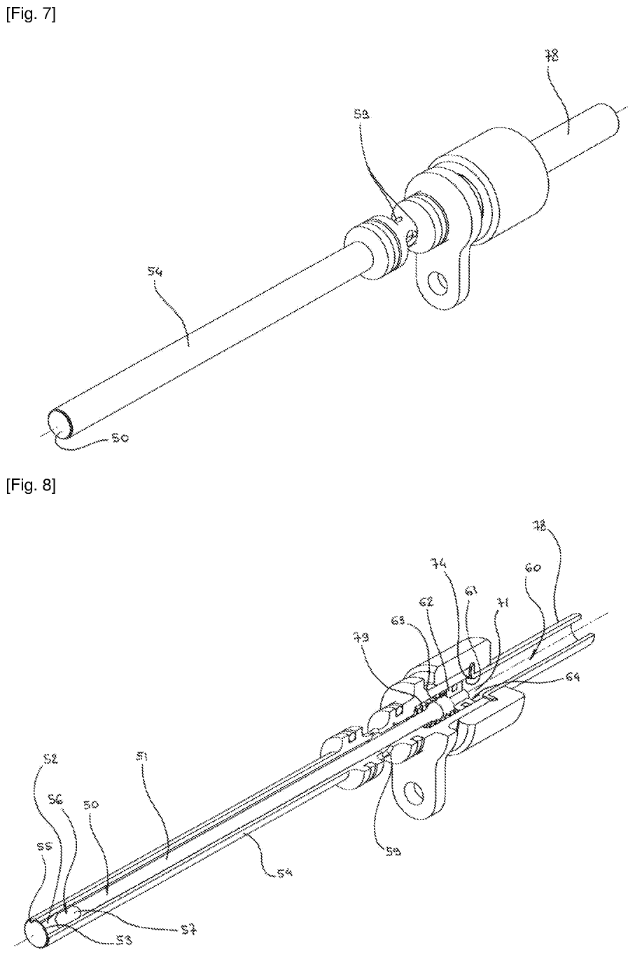

FIG. 7 is a three-dimensional view of the tubular injection nozzle of the hydraulic injection system with cam according to the invention, and of the main components which it accommodates or with which it cooperates.

FIG. 8 is a three-dimensional sectional view of the tubular injection nozzle of the hydraulic injection system with cam according to the invention and the main components which it accommodates or with which it cooperates.

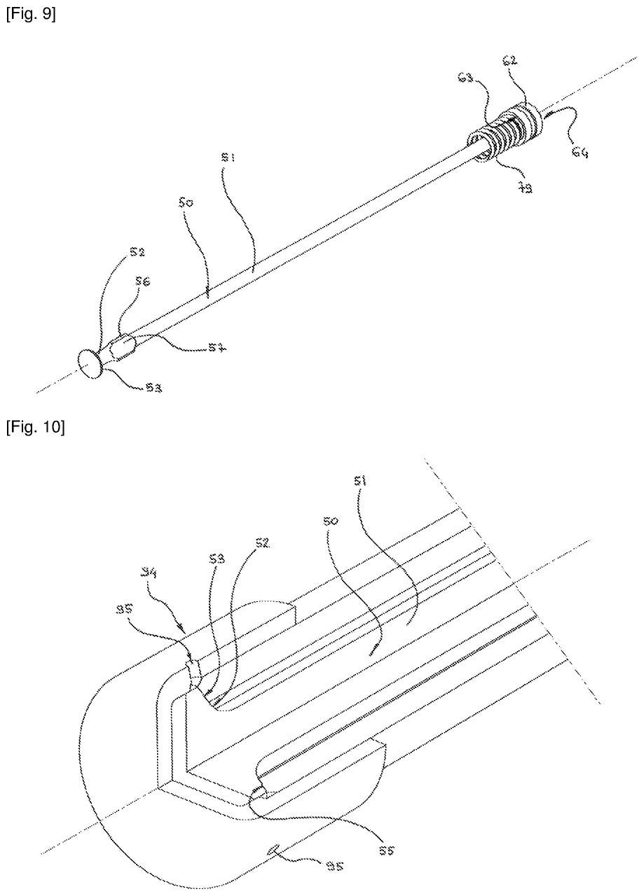

FIG. 9 is a three-dimensional view of the injection valve of the hydraulic injection system with cam according to the invention, equipped with the receiver piston and the receiver piston return spring.

FIG. 10 is a three-dimensional view of the perforated diffuser as it can be provided for terminating the injection nozzle of the hydraulic injection system with cam according to the invention.

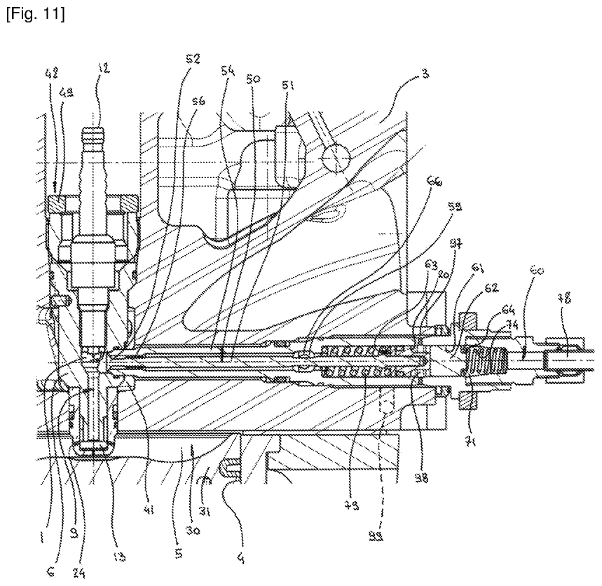

FIG. 11 is a schematic sectional view of the tubular injection nozzle of the hydraulic injection system with cam according to the invention and of the main components which it accommodates or with which it cooperates, as it can be installed in the cylinder head of an internal combustion engine equipped with a valve ignition pre-chamber according to French patent application No. FR 17 50264 and an ignition insert with active pre-chamber according to French patent application No. 3 060 222.

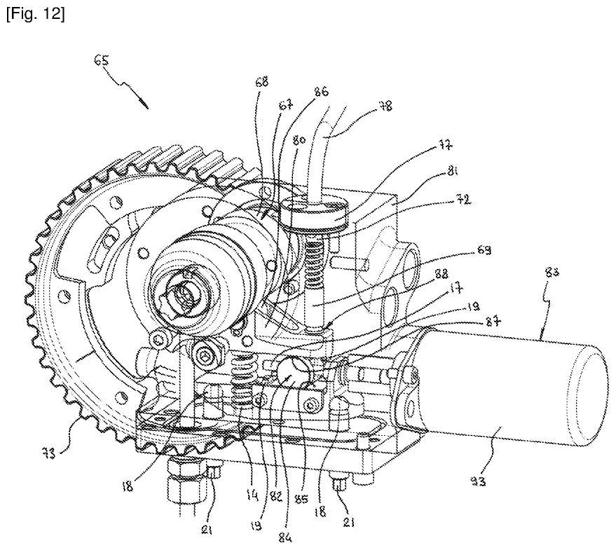

FIG. 12 is a three-dimensional phantom view of the injection cam of the hydraulic injection system with cam according to the invention, the movable pressing roller of which is provided with an internal thread in which the injector lift actuator can rotate a displacement screw.

### DESCRIPTION OF THE INVENTION

FIGS. 1 to 12 show the hydraulic injection system 100 with cam according to the invention, various details of its components, variants and accessories.

As shown in FIG. 1 and FIGS. 7 to 11, the hydraulic injection system 100 with cam comprises at least one injection valve 50 which comprises a valve stem 51 and ends in an enlarged end portion, or tulip, 52 which forms a valve sealing surface 53.

It can be seen in FIG. 1 and FIGS. 7 to 11 that the valve 50 is wholly or partly accommodated in a tubular injection nozzle 54 terminated by an injection valve seat 55 on which the valve sealing surface 53 can be sealingly seated, while a gap is formed between the valve stem 51 and the inner surface of the tubular injection nozzle 54 to allow an injectable fluid 58 pressurized by pressurizing means 10 to flow through. It is further noted that according to a particular method of manufacturing the hydraulic injection system with cam according to the invention, the valve sealing surface 53 may exhibit the shape of a truncated sphere while the injection valve seat 55 is conical.

In FIGS. 8, 9, 10 and 11, it can be seen that the hydraulic injection system 100 with cam provides permeable guide means 56 which are directly or indirectly fixed with respect to the injection valve 50 and/or the tubular injection nozzle 54. Said means 56 keep the injection valve 50 approximately centered in the tubular injection nozzle 54 regardless of the axial position of said valve 50 relative to said nozzle 54.

Note in FIGS. 8, 9, 10 and 11 that the permeable guide means 56 may comprise at least one gas passage channel 57 which allows the injectable fluid 58 to flow between the injection valve 50 and the tubular injection nozzle 54.

In FIGS. 7 and 8 and 11, it is noted that the hydraulic injection system 100 with cam comprises a nozzle inlet port 59 arranged in the tubular injection nozzle 54 and through which the injectable fluid 58 is introduced into said nozzle 54 after having been conveyed through an injectable fluid supply conduit 66 which connects the pressurizing means 10 to said port 59.

It is noted that the connection between the injectable fluid supply conduit 66 and the nozzle inlet port 59 can be made by welding, crimping, by means of a “banjo” fitting known per se, or by using a connecting block of any type.

In addition, the injectable fluid supply conduit 66 may be equipped with heating means for heating by electrical resistance, by external circulation of a heat transfer fluid such as water or oil, or by any other means. Said heating means advantageously make it possible to accelerate the rise in temperature of the injectable fluid supply conduit 66 during the start-up of the hydraulic injection system 100 with cam according to the invention in a low-temperature environment.

These means, or similar means, may also apply to the action hydraulic conduit 78 and/or the tubular injection nozzle 54.

As shown in particular in FIGS. 8 and 11, the hydraulic injection system 100 with cam comprises at least one receiver cylinder 61 which is directly or indirectly fixed with respect to the end of the tubular injection nozzle 54 which is located opposite the end of said nozzle 54 which receives the injection valve seat 55, said receiver cylinder 61 being positioned in the extension of said nozzle 54.

Also, FIGS. 1, 8, 9 and 11 show that the hydraulic injection system 100 with cam comprises at least one receiver piston 62 fixed with respect to the valve stem 51 and housed in the receiver cylinder 61, said piston 62 being capable to move in longitudinal translation in said cylinder 61 and having an axial face 63 on the injectable fluid side which communicates with the internal volume of the tubular injection nozzle 54, and an axial face 64 on the hydraulic fluid side which forms, with the receiver cylinder 61 and a receiver cylinder head 74 which terminates said cylinder 61, a receiver chamber 71 of variable volume.

It should be noted that the receiver piston 62 can be made in one or more parts and can receive a seal of any type, in particular a composite seal with a low coefficient of friction and high resistance to abrasion. This particular configuration can also be applied to the emitter piston 69.

In FIGS. 1 to 6 and in FIG. 12, it can be seen that the hydraulic injection system 100 with cam comprises a hydraulic fluid supply device 65 consisting of at least one injection cam 67 which has at least one cam profile 68 held directly or indirectly in contact with an action axial face 75 of an emitter piston 69 housed in an emitter cylinder 70.

It is noted, particularly in FIGS. 3 to 6 and in FIG. 12, that said piston 69 has—opposite the action axial face 75—an axial hydraulic fluid emitting face 76 which forms an emitting chamber 72 with the emitting cylinder 70 and an emitting cylinder head 77 which terminates said cylinder 70, while the cam profile 68 can move the emitting piston 69 in longitudinal translation in the emitting cylinder 70 when the injection cam 67 is rotated by a driving source 73.

The driving source 73 may be an electric motor, a hydraulic motor, the crankshaft of an internal combustion engine 2, or any other driving source 73 to which the injection cam 67 is connected by any type of transmission whether it is a shaft, a belt or a toothed belt, a chain, or sprockets.

It should be noted that if the injection cam 67 is driven by the crankshaft of an internal combustion engine 2, it may be fixed with respect to the camshaft of said engine 2, or placed at the end of the central shaft of an air compressor which forms the pressurizing means 10, or receive a dedicated pulley which is driven by the timing belt of said engine 2.

It can be seen, particularly in FIG. 1, that the hydraulic injection system 100 with cam comprises at least one action hydraulic conduit 78 which connects the emitter chamber 72 to the receiver chamber 71, said conduit 78, the emitter chamber 72 and the receiver chamber 71 being filled with a hydraulic fluid 60.

FIGS. 8, 9 and 11 illustrate that a receiver piston return spring 79 can be provided which tends to move the receiver piston 62 closer to the receiver cylinder head 74 with the result that the valve sealing seat 53 tends to be maintained in contact with the injection valve seat 55.

Said spring 79 may, for example, be housed in the receiver cylinder 61 and/or in the tubular injection nozzle 54 and be helical, or formed by a stack of spring washers or be of any other type known to skilled persons. It should be noted that a similar return spring may tend to bring the emitter piston 69 closer to the emitter cylinder head 77.

As FIG. 2 clearly illustrates, the cam profile 68 can comprise at least one angular lifting sector 15 which moves the emitter piston 69 when said sector 15 is in contact with the action axial face 75 and the injection cam 67 is rotating, and at least one angular maintaining sector 16 which is circular and centered on the axis of rotation of said injection cam 67 which immobilizes the emitter piston 69 when said sector 16 is in contact with the action axial face 75, and this, despite the fact that the injection cam 67 is rotating.

Note that the difference in radius of the cam profile 68 between that found at the maintaining angular sector 16 and the maximum radius found at the lift angular sector 15 determines the lift L produced by the injection cam 67 at the level of the cam profile 68. Taking into account possible mechanical and/or hydraulic lever arms, a higher or lower lift of the injection valve 50 corresponds to said L value.

In a variant embodiment of the hydraulic injection system 100 with cam according to the invention shown in FIG. 1, FIGS. 3 to 6 and FIG. 12, the cam profile 68 can be held in contact with the action axial face 75 by means of a rocker arm 80 which directly or indirectly bears on a cam housing 81 in which the injection cam 67 rotates.

It is noted in FIG. 1, in FIGS. 3 to 6, and in FIG. 12, that advantageously the rocker arm 80 can be maintained in contact with the cam profile 68 by means of a pressing roller 86 known per se which limits the friction losses at the interface between said rocker arm 80 and said cam profile 68.

It is also noted in FIG. 1, in FIGS. 3 to 6, and in FIG. 12, that according to a particular embodiment of the hydraulic injection system 100 with cam according to the invention, the rocker arm 80 can be held in contact either with the cam profile 68 or with the action axial face 75 by a rocker arm return spring 14.

In addition, the rocker arm 80 can cooperate with guide means not shown arranged in the cam housing 81 in such a way that said rocker arm 80 cannot rotate about an axis perpendicular to its operational rocking axis.

In FIG. 1, FIGS. 3 to 6 and FIG. 12 it can be seen that the rocker arm 80 can bear on the cam housing 81 via a movable rocker point 82 whose position between the cam profile 68 and the action axial face 75 can be changed by an injector lift actuator 83.

As can be easily deduced from FIG. 1, FIGS. 3 to 6 and FIG. 12, for the same cam profile 68, the position of the movable rocker point 82 determines the amount of displacement of the action axial face 75 and thus the lift height of the injection valve 50 relative to the injection valve seat 55 with which it cooperates.

Accordingly, if the tubular injection nozzle 54 opens into a volume at constant pressure, for a given rotational speed of the injection cam 67 and for a given pressure of the injectable fluid 58 in the injectable fluid supply conduit 66, the greater the lift height of the injection valve 50, the greater the quantity of injectable fluid 58 expelled from the tubular injection nozzle 54 via the passage formed between the valve sealing surface 53 and the injection valve seat 55.

FIG. 1, FIGS. 3 to 6, and FIG. 12 show that the movable rocker point 82 can advantageously be formed by a moveable pressing roller 84 which can roll or slide on a displacement track 85 formed in the cam housing 81, which roller 84 cooperates with a rocker track 87 on the back of the rocker arm 80.

It can be seen in FIG. 1, FIGS. 3 to 6 and FIG. 12 that the rocker arm 80 can advantageously be articulated about a ball joint 88 fixed with respect to the action axial face 75. As a refinement, the bearing roller 86 can have an external barrel shape. According to this particular configuration, the displacement track 85 and the tilting track 87 can be perfectly flat and the moveable pressing roller 84 perfectly cylindrical. This non-limiting configuration makes it possible to avoid any hyperstatic relationship between the various parts 84, 85, 86, 87 listed above, while avoiding the need to produce a cam profile 68 whose external axial surface is curved.

FIG. 6 clearly shows that the moveable pressing roller 84 can receive at each of its ends an orientation pinion 89, said pinions 89 being fixed in rotation, while each said pinion 89 cooperates with an orientation rack 90 which is fixed with respect to the cam housing 81.

This particular configuration makes it possible to keep the moveable pressing roller 84 perpendicular to the displacement track 85 with which it cooperates, and this irrespective of the position of the said roller 84 with respect to the said track 85.

FIG. 6 also clearly shows that the moveable pressing roller 84 can receive a worm wheel 91 which cooperates with a worm 92 whose axial position is fixed with respect to the cam housing 81. In this case, said worm 92 can be rotated by the injector lift actuator 83 which can be, as shown in FIG. 1 and

FIGS. 3 to 6, an electric stepper motor 93 with or without a gearbox of any type and controlled by an ECU.

It should be noted that the electric stepper motor 93 as well as any injector lift actuator 83 can be connected to the worm screw 92 directly or via a transmission by belt, chain, sprockets, or any other type known to skilled persons.

Thus, when the injector lift actuator 83 rotates the worm screw 92, the moveable pressing roller 84 moves relative to the displacement track 85 with which it cooperates, resulting in a displacement of the position of the movable rocker point 82 relative to the cam housing 81. This makes it possible to adjust the quantity of injectable fluid 58 expelled from the tubular injection nozzle 54.

Note that one and the same movable pressing roller 84 can cooperate with several rocker arms 80 to vary the lever arm simultaneously, or one and the same electric stepper motor 93 can move several movable pressing rollers 84.

Alternatively, as shown in FIG. 12, the moveable pressing roller 84 can be provided with a threaded bore in which the injector lift actuator 83 can rotate a displacement screw 17 which is fixed in position to the cam housing 81 but free to rotate about its longitudinal axis, thereby causing the moveable pressing roller 84 to slide on the displacement track 85.

In FIG. 1, it has been shown that an injection cam phase shifter 96 can be interposed between the injection cam 67 and the driving source 73, said phase shifter 96 making it possible to advance or delay angularly with respect to the driving source 73 the movement which the injection cam 67 imparts to the emitting piston 69, for example when the said source 73 consists of the crankshaft of an internal combustion engine 2.

It should be noted that the principle of the injection cam phase shifter 96 may be similar to that of hydraulic or electric camshaft phase shifters of automotive internal combustion engines.

In FIG. 10, it has been shown that the end of the tubular injection nozzle 54 that ends in the injection valve seat 55 can be capped with a perforated diffuser 94 that forces the injectable fluid 58 expelled from the tubular injection nozzle 54 via the passage formed between the valve sealing surface 53 and the injection valve seat 55 to pass through one or more ejection orifices 95 so as to create jets of injectable fluid 58.

According to this variant of the hydraulic injection system 100 with cam according to the invention, at least part of the inner wall of the perforated diffuser 94 may be cylindrical and form a small clearance between itself and the outer peripheral surface of the tulip 52 so that said diffuser 94 forms the permeable guide means 56.

Finally, FIG. 1 shows that a charge pump 7 can be provided which tends to introduce hydraulic fluid 60 into the action hydraulic conduit 78 via a charge check valve 8, said hydraulic fluid 60 coming from a hydraulic fluid tank 11.

It is noted that according to a particular embodiment of the hydraulic injection system 100 with cam according to the invention, the charge pump 7 can be constituted by the lubrication pump of an internal combustion engine 2, whereas the hydraulic fluid tank 11 is constituted by the oil sump of said engine 2. It is further noted that the action hydraulic conduit 78 may comprise a pressure limiter and purging devices known per se.

As shown in FIG. 11, it can be seen that the hydraulic injection system 100 with cam according to the invention can receive at least one drain orifice 97 which is connected to a drain conduit 99 and opens into the receiver cylinder 61. It is understood that in this case, the axial face 63 on the injectable fluid side and the axial face 64 on the hydraulic fluid side always remain axially positioned on either side of said orifice 97 regardless of the position of the receiver piston 62.

According to this particular configuration, the receiver piston 62 has a drainage groove 98 which communicates with the drainage orifice 97, said groove 98 collecting, on the one hand, injectable fluid 58 leaking between the receiver piston 62 and the receiver cylinder 61 from the axial face 63 on the injectable fluid side and, on the other hand, hydraulic fluid 60 and/or air leaking between said piston 62 and said cylinder 61 from the hydraulic fluid-side axial face 64, so that said injectable fluid 58, said hydraulic fluid 60 and/or said air can be discharged via the drain conduit 99.

It is noted that the drainage groove 98, the drainage port 97 and the drainage conduit 99 thereby permanently purge the action hydraulic conduit 78 of any air detrimental to the proper functioning of the hydraulic injection system 100 with cam according to the invention.

In FIG. 11, it can be seen that the receiver piston 62 can be made up of a first body which receives the axial face 63 on the injectable fluid side and which is fixed with respect to the valve stem 51, and of a second body which may or may not be fixed with respect to said first body and which receives the axial face 64 on the hydraulic fluid side, an external shoulder 20 provided on one, the other or both of said bodies forming the drainage groove 98.

It is noted in FIG. 12 that the maximum range of displacement of the movable rocker point 82 between the cam profile 68 and the action axial face 75 can advantageously be determined by at least one end-of-stroke stop 19 which constitutes, inter alia, a geometrical reference position which can be used by the injector lift actuator 83 to readjust the position of the movable rocker point 82, and adjust the correct amount of injectable fluid 58 expelled from the tubular injection nozzle 54 via the passage formed between the valve sealing surface 53 and the injection valve seat 55.

FIG. 12 also illustrates that the displacement track 85 can be made fixed with respect to the cam housing 81 by means of at least one track orientation ball joint 18 which allows said track 85 to conform to the orientation of the rocker arm 80, said orientation being imposed by the geometric environment of said rocker arm 80.

As shown in FIG. 12, in accordance with a variant embodiment of the hydraulic injection system 100 with cam according to the invention, the axial position of the track ball joint 18 in the cam housing 81 can be adjusted by means of an adjusting screw 21.

### OPERATION OF THE INVENTION

The operation of the hydraulic injection system 100 with cam according to the invention is easily understood from FIGS. 1 to 12.

In order to detail the operation of said system 100, the valve ignition pre-chamber which was the subject of French patent application No. FR 17 50264 is applied here, said pre-chamber receiving, on the one hand, the valve magnetic return device which is the subject of French patent application No. 18 58111 and, on the other hand, the active pre-chamber ignition insert which is the subject of French patent application No. 1904961.

FIGS. 1 and 11 show the hydraulic injection system 100 with cam which, according to this non-restrictive example, equips an internal combustion engine 2 which comprises in particular a cylinder 4 topped by a cylinder head 3, said cylinder 4 and said cylinder head 3 forming, with a piston 31, a combustion chamber 5.

In FIGS. 1 and 11, the valve ignition pre-chamber 1 is shown, being arranged in an ignition insert with an active pre-chamber 6 accommodated in the cylinder head 3. FIGS. 1 and 11 also show that the tubular injection nozzle 54 and the injection valve 50 open into the valve ignition pre-chamber 1 for the introduction of an injectable fluid 58 which, according to this example, consists of a highly flammable AF mixture of air and gasoline.

Said AF mixture forms a pilot charge 9 which is intended to be ignited by a spark plug 12 which exits into the flap ignition pre-chamber 1. Once ignited, this pilot charge 9 will be ejected through gas ejection orifices 24 into combustion chamber 5 in the form of high-temperature gas flares. Said flares are intended to ignite a main charge 30 contained in said combustion chamber 5.

In FIGS. 1 and 11, it can be seen that the valve pre-ignition chamber 1 and combustion chamber 5 are separated by a valve member 13 which is returned to its seat by a permanent magnet 49 which is part of the valve magnetic return device 42 as described in French patent application No. 18 58111 belonging to the applicant. Said valve member 13 allows the gases contained in the valve pre-chamber 1 to flow into combustion chamber 5 but prevents the gases contained in said chamber 5 from entering the valve ignition pre-chamber 1.

When closed, the valve member 13 makes the valve ignition pre-chamber 1 into a closed volume with a lower pressure and temperature than those in the combustion chamber 5. This thereby prevents any self-ignition risk of the pilot charge 9 in said pre-chamber 1.

With the valve 13 closed, the tubular injection nozzle 54 can inject the required highly flammable pilot charge 9 into the valve ignition pre-chamber 1 without any risk of mixing the pilot charge 9 with the main charge 30 which, being difficult to ignite, must be brought to a higher pressure and temperature to allow and promote the ignition thereof.

It should be noted that the special configuration shown in FIGS. 1 and 11 of cylinder head 3 and active pre-chamber ignition insert 6 requires a tubular injection nozzle 54 having a great length. The latter is incompatible with the technological and manufacturing constraints of compact and economical injectors usually used in motor vehicles. However, said great length does not pose any particular problem if the hydraulic injection system 100 with cam according to the invention is used.

It will be assumed here that the pressure of the injectable fluid 58 supplied to the tubular injection nozzle 54 by the pressurizing means 10 is fifty bars. This pressure must not be exceeded because the injectable fluid 58 consists of an AF gaseous mixture of air and gasoline. Indeed, the injectable fluid 58 shall be maintained at a temperature of one hundred degrees Celsius. This temperature is imposed by the water circulating in the cooling water chambers 41 of cylinder head 3 of the internal combustion engine 2. However, if the pressure of injectable fluid 58 at such a temperature exceeds fifty bars, some of the gasoline in the AF gaseous mixture will inevitably condense.

It should be remembered that the tubular injection nozzle 54 injects the injectable fluid 58 into the valve ignition pre-chamber 1 to form the pilot charge 9 during the compression stroke of the internal combustion engine 2, taking care to ensure that the pressure in said pre-chamber 1 always remains lower than the pressure in the combustion chamber 5.

This constraint leads to an injection duration of the pilot charge 9 limited, for example, to forty degrees of crankshaft of the internal combustion engine 2.

The length, temperature and pressure constraints described above make the hydraulic injection system 100 with cam according to the invention particularly interesting. In fact, said system 100 makes it possible to produce a long and compact tubular injection nozzle 54 capable of injecting the necessary pilot charge 9 into the valve ignition pre-chamber 1 in less than forty crankshaft degrees, despite an upstream pressure of the injectable fluid 58 limited to fifty bars due to its temperature limited to one hundred degrees Celsius.

In order to achieve this result, it can be seen in FIGS. 8 and 11 that the section of the axial face 63 on the injectable fluid side of the receiver piston 62 exposed to the pressure of the injectable fluid 58 is designed so as to be larger than the section exposed to said pressure by the tulip 52 of the injection valve 50 when said valve 50 rests on the injection valve seat 55 with which it cooperates.

Consequently, the pressure in the tubular injection nozzle 54 tends to press the valve sealing surface 53 against the injection valve seat 55 and to keep the injection valve 50 closed, with the additional action of the receiver piston return spring 79. This high return force generated by the pressure of the injectable fluid 58 makes it possible to avoid the need for a high force receiver piston return spring 79, which would be heavy and cumbersome.

In connection with FIG. 1, it will be assumed that the charge pump 7, which supplies hydraulic fluid 60 to the action hydraulic conduit 78 via the charge check valve 8, is the lubrication pump of the internal combustion engine 2, while the hydraulic fluid tank 11 consists of the oil sump of the internal combustion engine 2.

In this context, advantageously, the force of the receiver piston return spring 79 is provided so as to be considerably greater than the force of the pressure generated by the lubricating pump of the internal combustion engine 2 on the receiver piston 62.

It can also be seen from FIGS. 1 and 11 that in this case the injectable fluid supply conduit 66 is arranged directly in the cylinder head casting 3, while the injection cam 67 is driven by the camshaft of the internal combustion engine 2.

It will be assumed here that, as shown in FIG. 1, FIGS. 3 to 6 and FIG. 12, the cam profile 68 of the injection cam 67 is held in contact with the action axial face 75 of the emitter piston 69 via a rocker arm 80, the latter being held in contact with the cam profile 68 via a pressing roller 86.

As shown in FIG. 1, FIGS. 3 to 6, and FIG. 12, it is also assumed that the rocker arm 80 bears on the cam housing 81 via a moveable pressing roller 84 which can roll or slide on a displacement track 85 provided in the cam housing 81, said roller 84 cooperating with a tilting track 87 provided on the back of the rocker arm 80.

In FIG. 1, FIGS. 3 to 6, and FIG. 12, it can be seen that the displacement track 85 is advantageously perfectly perpendicular to the axis of the emitting piston 69. In addition, in FIGS. 1, 3, 5, 6 and 12, it can be seen that when the pressing roller 86 is in contact with the angular maintaining sector 16 and the emitting piston 69 pushes on the rocker arm 80 via its action axial face 75 in order to press the rocker arm 80 onto the displacement track 85 via the movable pressing roller 84, the tilting track 87 of the rocker arm 80 remains parallel to the displacement track 85 whatever the position of the movable pressing roller 84.

It is noted in this respect that it is possible to provide a screw or cam adjustment device or any other adjustment means which makes it possible to adjust the perpendicularity of the displacement track 85 with respect to the axis of the emitting piston 69 and/or the distance of the displacement track 85 from the injection cam 67 along an axis parallel to that of the emitting piston 69. It can be seen in FIG. 12 that said adjusting device can be designed as adjusting screws 21.

In order to avoid any inaccuracy in the settings described above, it is advantageous to allow a small amount of hydraulic fluid 60 to escape directly or indirectly from action hydraulic conduit 78 with each opening cycle of injection valve 50. This can take place, for example, via the emitter piston 69, which is imperfectly sealed, or via a nozzle of very small section placed at any point in the circuit connecting the emitter chamber 72 to the receiver chamber 71, said nozzle allowing some hydraulic fluid 60 to escape and return to the hydraulic fluid tank 11.

It can be seen, particularly in FIG. 6, that the movable pressing roller 84 receives at each of its ends an orientation pinion 89, said pinions 89 being fixed in rotation, while each said pinion 89 cooperates with an orientation rack 90 integral with the cam housing 81.

It is also noted that the moveable pressing roller 84 receives a worm wheel 91 which cooperates with a worm 92 whose axial position is fixed with respect to the cam housing 81, said worm 92 being driven in rotation by the injector lift actuator 83 which, according to this non-limiting example, consists of an electric stepper motor 93.

It should be noted that, advantageously, the pitch circle diameter of the orientation pinions 89 and that of the worm wheel 91 are identical, which does not exclude the possibility that they are different.

Thus, when the electric stepper motor 93 rotates the worm wheel 92, the moveable pressing roller 84 moves in relation to the displacement track 85 with which it cooperates, with the result that the position of the moveable rocker point 82 moves in relation to the cam housing 81.

This makes it possible to adjust the quantity of injectable fluid 58 expelled from the tubular injection nozzle 54 to the valve ignition pre-chamber 1.

When the internal combustion engine 2 is running, the injection valve 50, for example, is first kept closed by the receiver piston 62 due to the pressure in the injection nozzle tube and, to a lesser extent, by the receiver piston return spring 79. This situation is illustrated in FIGS. 1 and 11 and results, for example, from any of the angular positions of the injection cam 67 shown in FIG. 1, 3, 5 or 6.

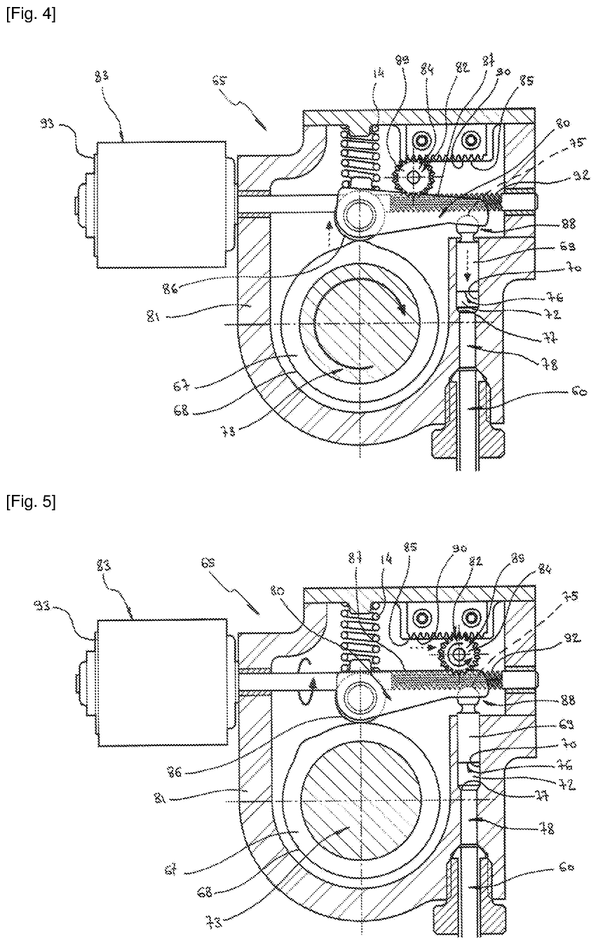

As shown in FIG. 4, with the internal combustion engine 2 still running, the cam profile 68 pushes on the rocker arm 80. The rocker arm 80 tilts and moves the emitter piston 69 which, in turn, forces hydraulic fluid 60 from the emitter chamber 72 to the receiver chamber 71. This displaces the receiver piston 62 and moves the valve sealing surface 53 away from the injection valve seat 55, resulting in the transfer of injectable fluid 58 from the tubular injection nozzle 54 to the valve ignition pre-chamber 1.

FIG. 5 shows that, in order to adjust the lift height of the injection valve 50, the electric stepper motor 93 can move the movable pressing roller 84 towards or away from the emitter piston 69 via the worm screw 92, in order to change the lever arm of the rocker arm 80 and thus the displacement ratio between that of the emitter piston 69 and that of the receiver piston 62.

In practice, the displacement ratio between the displacement of the emitter piston 69 and the effective lift of the injection valve 50 depends on the lever arm of the rocker arm 80, but also on the compressibility of the hydraulic fluid 60 in the emitter chamber 72, the receiver chamber 71 and the action hydraulic conduit 78.

The force to be applied by the rocker arm 80 to the action axial face 75 of the emitter piston 69 is dependent in particular on the pressure of the injectable fluid 58 in the tubular injection nozzle 54 and on the ratio between the section exposed to the pressure of the injectable fluid 58 via the axial face 63 on the injectable fluid side and the section exposed to this pressure via the tulip 52.

To a lesser extent, said force is also dependent on the force produced by the receiver piston return spring 79. In addition to this, there is the inertia of the various moving parts and the energy losses which they produce by rubbing against each other, and the pressure losses produced by the hydraulic fluid 60 flowing in particular in the action hydraulic conduit 78.

However, for each operating point of the internal combustion engine 2 there is a position of the electric stepper motor 93 which allows the pilot charge quantity 9 most favorable to the thermodynamic efficiency of the internal combustion engine 2 to be introduced into the valve ignition pre-chamber 1. Finding the existing relationship between the position of the electric stepper motor 93 and the pilot charge quantity 9 can be carried out on the test bench for each operating point of the internal combustion engine 2, thus avoiding the development of a predictive numerical model, which is useless in this context.

Consequently, the position of the electric stepper motor 93 is designed to vary as required, in particular as a function of the speed, load, and dilution of the main load 30 of the internal combustion engine 2. With regard to said dilution, it should be noted that the more the main charge 30 is diluted with fresh air or with recirculated exhaust gases, the more resistant it is to ignition, and the greater the energy contained in the pilot charge 9 must be relative to that contained in the main charge 30.

Furthermore, to introduce the same amount of pilot charge 9, the faster the internal combustion engine 2 is running, the higher the lift of injection valve 50 must be. Indeed, for the same position of the movable pressing roller 84, the faster the engine 2 is running, the shorter the absolute duration of the injection valve lift 50 is, in order to inject the same mass of injectable fluid 58 into the valve ignition pre-chamber 1. The reduction in the injection duration must therefore be compensated for by increasing the flow cross-section existing between the valve sealing surface 53 and the injection valve seat 55 and thus by increasing the injection valve lift 50.

It can also be seen that, since the internal combustion engine 2 is running fast, the effects of the compressibility of the hydraulic fluid 60 are more pronounced due to the increased acceleration of the parts to be moved and the resulting increase in the peak pressure reached by said fluid 60. This effect is also to be compensated for by an appropriate position of the movable pressing roller 84 via the electric stepper motor 93.

The map of the ideal position of the electric stepper motor 93 taking into account the operating conditions of the internal combustion engine 2 is stored in the memory of a computer 48, corrected or not by algorithms taking into account contextual operating parameters such as temperature or ageing.

It should be noted that when the internal combustion engine 2 starts at very low temperatures—for example minus thirty degrees Celsius—the pressure of the injectable fluid 58 in the injectable fluid supply conduit 66 and in the tubular injection nozzle 54 must be drastically reduced, for example to five bar instead of fifty bar.

This lower pressure ensures that the gasoline in the AF gasoline/air mixture does not condense and that the nominal richness of the AF gasoline/air mixture is maintained. As a result, during the warm-up phase of the internal combustion engine 2, the maximum load of the engine is limited to about ten bar mean effective pressure, which makes any motor vehicle equipped with it immediately usable.

A few seconds later, the rapid temperature rise of the pressurizing means 10, the injectable fluid supply conduit 66 and the tubular injection nozzle 54 allows normal operation to be resumed, with the pressure of the injectable fluid 58 in the tubular injection nozzle 54 reaching approx. fifty bar.

The above example of operation of the hydraulic injection system 100 with cam according to the invention is by no means limiting. Indeed, said system is capable of allowing the direct or indirect injection of natural gas, heavy fuel oil, diesel oil or gasoline into any internal combustion engine 2, whatever the principle thereof.

In general, the hydraulic injection system 100 with cam according to the invention is capable of allowing the injection of any gas and/or any liquid into any machine requiring such injection, whether or not controlled by an injector lift actuator 83.

Also, the possibilities of the hydraulic injection system 100 with cam following the invention are not limited to the applications described above and it must moreover be understood that the preceding description has been given only as an example and that it does not in any way limit the field of said invention from which one would not depart by replacing the execution details described by any other equivalent.

1. Hydraulic injection system (100) with cam, characterized in that it comprises:
at least one injection valve (50) which comprises a valve stem (51) and terminates in an enlarged portion, or tulip, (52), the latter forming a valve sealing seat (53), said valve (50) being wholly or partially housed in a tubular injection nozzle (54) terminated by an injection valve seat (55) on which the valve sealing surface (53) can rest sealingly while a gap is formed between the valve stem (51) and the inner surface of the tubular injection nozzle (54) to allow an injectable fluid (58) pressurized by pressurizing means (10) to flow;
At least one nozzle inlet port (59) provided in the tubular injection nozzle (54) and through which the injectable fluid (58) is introduced into said nozzle (54);
At least one receiver cylinder (61) which is directly or indirectly fixed with respect to the end of the tubular injection nozzle (54);
At least one receiver piston (62) fixed with respect to the valve stem (51) and housed in the receiver cylinder (61), said piston (62) being capable to move in longitudinal translation in said cylinder (61) and having an axial face (63) on the injectable fluid side which communicates with the internal volume of the tubular injection nozzle (54), and an axial face (64) on the hydraulic fluid side which forms, with the receiver cylinder (61), a variable-volume receiver chamber (71) filled with a hydraulic fluid (60);
at least one hydraulic fluid supply device (65) which is connected to the receiver chamber (71) and making it possible to actuate the receiver piston (62) by means of the hydraulic fluid (60) via an action hydraulic conduit (78).

2. Hydraulic injection system with cam according to claim 1, characterized in that a receiver piston return spring (79) tends to move the receiver piston (62) closer to a receiver cylinder head (74).

3. Hydraulic injection system with cam according to claim 1, characterized in that permeable guide means (56) are directly or indirectly fixed with respect to the injection valve (50) and/or the tubular injection nozzle (54), said means (56) keeping the injection valve (50) approximately centered in the tubular injection nozzle (54).

4. Hydraulic injection system with cam according to claim 1, characterized in that the hydraulic fluid supply device (65) consists of an injection cam (67) which has at least one cam profile (68) held directly or indirectly in contact with an action axial face (75) of an emitter piston (69) accommodated in an emitter cylinder (70), said piston (69) having—opposite the action axial face (75)—an axial hydraulic fluid emitting face (76) which forms an emitting chamber (72) with the emitting cylinder (70), while the cam profile (68) can move the emitting piston (69) in longitudinal translation in the emitting cylinder (70) when the injection cam (67) is rotated by a drive source (73).

5. Hydraulic injection system with cam according to claim 4, characterized in that the action hydraulic conduit (78) connects the emitter chamber (72) to the receiver chamber (71), the conduit (78), emitter chamber (72) and receiver chamber (71) being filled with hydraulic fluid (60).

6. Hydraulic injection system with cam according to claim 4, characterized in that the cam profile (68) comprises at least one angular lifting sector (15) which moves the emitter piston (69) when said sector (15) is in contact with the axial acting face (75) and when the injection cam (67) is rotating, and at least one angular maintaining sector (16), circular and centered on the axis of rotation of said injection cam (67) which immobilizes the emitter piston (69) when said sector (16) is in contact with the action axial face (75), and this, despite the fact that the injection cam (67) is rotating.

7. Hydraulic injection system with cam according to claim 4, characterized in that the cam profile (68) is held in contact with the action axial face (75) by means of a rocker arm (80) which is directly or indirectly supported on a cam housing (81) in which the injection cam (67) rotates.

8. Hydraulic injection system with cam according to claim 7, characterized in that the rocker arm (80) is supported on the cam housing (81) via a moveable rocker point (82), the position of which between the cam profile (68) and the axial acting face (75) can be varied by an injector lift actuator (83).

9. Hydraulic injection system with cam according to claim 8, characterized in that the moveable rocker point (82) consists of a moveable pressing roller (84) which can roll or slide on a displacement track (85) provided in the cam housing (81), said roller (84) cooperating with a rocker track (87) provided on the back of the rocker arm (80).

10. Hydraulic injection system with cam according to claim 9, characterized in that the moveable pressing roller (84) receives at each of its ends an orientation pinion (89), said pinions (89) being fixed in rotation, while each said pinion (89) cooperates with an orientation rack (90) secured on the cam casing (81).

11. Hydraulic injection system with cam according to claim 10, characterized in that the moveable pressing roller (84) receives a worm wheel (91) which cooperates with a worm (92) whose axial position is fixed with respect to the cam housing (81), said worm (92) being rotatably driven by the injector lift actuator (83).

12. Hydraulic injection system with cam according to claim 10, characterized in that the moveable pressing roller (84) is provided with an internal thread in which the injector lift actuator (83) can rotate a displacement screw (17) which is fixed in position with respect to the cam housing (81) but free to rotate about its longitudinal axis.

13. Hydraulic injection system with cam according to claim 4, characterized in that an injection cam phase shifter (96) is interposed between the injection cam (67) and the driving source (73).

14. The hydraulic injection system with cam according to claim 1, characterized in that the end of the tubular injection nozzle (54) which terminates with the injection valve seat (55) is capped by a perforated diffuser (94).

15. Hydraulic injection system with cam according to claim 14, characterized in that at least a portion of the inner wall of the perforated diffuser (94) is cylindrical and forms a small clearance between itself and the outer peripheral surface of the tulip (52) so that said diffuser (94) forms the permeable guide means (56).

16. Hydraulic injection system with cam according to claim 1, characterized in that a charge pump (7) tends to introduce hydraulic fluid (60) into the action hydraulic conduit (78) via a charge check valve (8), said hydraulic fluid (60) coming from a hydraulic fluid tank (11).

17. Hydraulic injection cam system according to claim 1, characterized in that at least one drainage orifice (97) connected to a drainage conduit (99) opens into the receiver cylinder (61), the axial face (63) on the injectable fluid side and the axial face (64) on the hydraulic fluid side always remaining axially positioned on either side of said orifice (97) regardless of the position of the receiver piston (62).

18. Hydraulic injection system with cam according to claim 17, characterized in that the receiver piston (62) has a drain groove (98) which communicates with the drain orifice (97).

19. Hydraulic injection cam system according to claim 18, characterized in that the receiver piston (62) is constituted by a first body which receives the axial face (63) on the injectable fluid side and which is fixed with respect to the valve stem (51), and by a second body which may or may not be fixed with respect to said first body and which receives the axial face (64) on the hydraulic fluid side, an external shoulder (20) provided on one, the other or both of said bodies forming the drainage groove (98).

20. Hydraulic injection system with cam according to claim 8, characterized in that the maximum range of displacement of the moveable rocker point (82) between the cam profile (68) and the action axial face (75) is determined by at least one end-of-stroke stop (19).

21. Hydraulic injection system with cam according to claim 9, characterized in that the displacement track (85) is fixedly connected to the cam housing (81) by means of at least one track orientation ball joint (18).

22. Hydraulic injection cam system according to claim 1, characterized in that the receiver piston (62) is made up of at least one first body which receives the axial face (63) on the injectable fluid side and which is fixed with respect to the valve stem (51), and of at least one second body which may or may not be fixed with respect to said first body and which receives the axial face (64) on the hydraulic fluid side.

23. Hydraulic injection cam system according to claim 22, characterized in that the receiver piston (62) comprises an external shoulder (20) arranged on one, the other or both bodies, said shoulder (20) forming a drainage groove (98) which communicates with at least one drainage orifice (97) which is arranged in the receiver cylinder (61) and which is connected to a drainage conduit (99).
